(19) United States
(12) Patent Application Publication
(10) Pub. No.: US 2026/0008286 A1
(43) Pub. Date: Jan. 8, 2026

(54) MEDIUM TRANSPORT DEVICE AND RECORDING DEVICE

(71) Applicant: SEIKO EPSON CORPORATION, Tokyo (JP)

(72) Inventors: Shun HARA, MATSUMOTO-SHI (JP); Morihiko YAMADA, OKAYA-SHI (JP)

(21) Appl. No.: 19/260,889

(22) Filed: Jul. 7, 2025

(30) Foreign Application Priority Data
Jul. 8, 2024 (JP) 2024-109442

(51) Int. Cl. B41J 29/17; B41J 11/00; B41J 13/02; B41J 13/03; B41J 13/32; B41J 29/13

(52) U.S. Cl. CPC B41J 29/17; B41J 11/0095; B41J 13/025; B41J 13/03; B41J 13/32; B41J 29/13

(57) ABSTRACT

A medium transport device 1 includes a transport section 120 configured to transport a medium P; a detection section 101 configured to detect the medium P transported by the transport section 120 via a detection surface 101A; a cleaning section 110 configured to clean the detection surface 101A; a housing 53 configured to house the transport section 120, the detection section 101, and the cleaning section 110; and a door section 6 configured to open and close the housing 53, wherein the cleaning section 110 is configured to slide with respect to the detection surface 101A in conjunction with opening and closing of the door section 6.

The present application is based on, and claims priority from JP Application Serial Number 2024-109442, filed Jul. 8, 2024, the disclosure of which is hereby incorporated by reference herein in its entirety.

### BACKGROUND

### 1. Technical Field

The present disclosure relates to a medium transport device and a recording device.

### 2. Related Art

Various medium transport device such as an inkjet printer that transport a medium have been used. Among these, there is the medium transport device including a detection section that detects the medium to be transported. For example, JP-A-2014-13361 discloses a color laser printer including a sensor for detecting a paper sheet to be transported.

The color laser printer of JP-A-2014-13361 is configured so that by moving the sensor to a shielding position, the sensor is brought into contact with a cleaning member provided on a shielding member, thereby making it possible to clean a detection surface of the sensor. That is, when the detection surface of the sensor is cleaned, the sensor is moved for cleaning. However, the sensor itself may be increased in size depending on the type of the sensor. Therefore, in the configuration of the color laser printer disclosed in JP-A-2014-13361 in which the sensor is moved for cleaning, the sensor itself is increased in size, and thus the configuration for moving the sensor with respect to the cleaning member is also increased in size, which may result in an increase in size of the device.

### SUMMARY

In order to solve the above problem, the medium transport device includes a transport section configured to transport a medium; a detection section that has a detection surface and that is configured to detect the medium transported by the transport section via a detection surface; a cleaning section configured to clean the detection surface; a housing configured to house the transport section, the detection section, and the cleaning section; and a door section configured to open and close the housing, wherein the cleaning section is configured to slide with respect to the detection surface in conjunction with opening and closing of the door section.

### BRIEF DESCRIPTION OF THE DRAWINGS

FIG. 1 is a perspective view showing the appearance of a recording device as a medium transport device according to an embodiment of the present disclosure.

FIG. 2 is an internal configuration diagram of a part of the recording device of FIG. 1 viewed from the front side.

FIG. 3 is a perspective view of the periphery of a support section having a detection section and a cleaning section of the recording device of FIG. 1.

FIG. 4 is a front view of the support section and an opening and closing cover of the recording device of FIG. 1.

FIG. 5 is a front view of the periphery of the support section of the recording device of FIG. 1, showing a state where the opening and closing cover is closed.

FIG. 6 is a front view of the periphery of the support section of the recording device of FIG. 1, showing a state where the opening and closing cover is opened.

FIG. 7 is a perspective view of the periphery of a lever of a support section of the recording device of FIG. 1.

FIG. 8 is a side view of the periphery of the lever of the support section of the recording device of FIG. 1 and is a view showing a state where a tip end of the lever is separated from a frame section by the opening and closing cover being closed.

FIG. 9 is a side view of the periphery of the lever of the support section of the recording device of FIG. 1 and is a view showing a state where the tip end of the lever is in contact with the frame section by the opening and closing cover being opened.

FIG. 10 is a plan view of the periphery of the support section of the recording device of FIG. 1.

FIG. 11 is a side view of the periphery of the support section of the recording device of FIG. 1, showing a state where the opening and closing cover is closed.

FIG. 12 is a side view of the periphery of the support section of the recording device of FIG. 1, showing a state where the opening and closing cover is opened.

### DESCRIPTION OF EMBODIMENTS

Hereinafter, the present disclosure will be generally described.

A medium transport device according to a first aspect of the present disclosure includes a transport section configured to transport a medium; a detection section that has a detection surface and that is configured to detect the medium transported by the transport section via a detection surface; a cleaning section configured to clean the detection surface; a housing configured to house the transport section, the detection section, and the cleaning section; and a door section configured to open and close the housing, wherein the cleaning section is configured to slide with respect to the detection surface in conjunction with opening and closing of the door section.

According to the present aspect, the cleaning section is configured to slide with respect to the detection surface in conjunction with opening and closing of the door section. That is, since the cleaning section is configured to slide with respect to the detection surface of the detection section, it is possible to reduce the space inside the housing for cleaning and to suppress an increase in the size of the medium transport device. Further, since the cleaning is performed in conjunction with the opening and closing of the door section, a dedicated power source or the like is not required, and thus, the cost can be suppressed.

The medium transport device according to a second aspect of the present disclosure is an aspect dependent on the first aspect, wherein the transport section has a path member that configures a transport path of the medium, the path member has a transport surface, the medium is transported facing the transport surface, and the detection section is provided on the opposite side than the transport surface with respect to the path member, and the cleaning section is configured to slide with respect to the detection surface by moving in a direction along the transport surface in a gap between the path member and the detection section.

According to the present aspect, the detection section is provided on the opposite side of the transport surface with respect to the path member, and the cleaning section is configured to slide with respect to the detection surface by moving in the direction along the transport surface in the gap between the path member and the detection section. With such a configuration, the detection section can be disposed inside the transport surface of the path member, and a decrease in detection accuracy caused by the detection section rubbing against the medium can be suppressed.

The medium transport device according to a third aspect of the present disclosure is an aspect dependent on the first or second aspect, wherein the transport section has a path member that configures a transport path of the medium, the path member has a transport surface, the medium is transported facing the transport surface, and the detection section is provided in the path member.

According to the present aspect, the detection section is provided in the path member which configures the transport path of the medium. In the case of a configuration in which the detection section is provided in the path member, depending on the device configuration, the path member may be moved together when cleaning the detection section, and there is a concern that the movement space of the path member or the configuration for moving the path member may be increased in size. However, since the cleaning section can be configured to slide with respect to the detection section, it is possible to suppress an increase in the size of the medium transport device.

The medium transport device according to a fourth aspect of the present disclosure is an aspect dependent on the third aspect, wherein the path member is configured to displace between a transport position where the medium is transported and a retract position where the medium is retracted from the transport position and takes the transport position when the door section is closed and takes the retract position when the door section is open.

According to the present aspect, the path member takes the transport position when the door section is closed and takes the retract position when the door section is opened. With such a configuration, the path member is retracted by opening the door section, and thus, it is possible to facilitate maintenance such as jam processing.

The medium transport device according to a fifth aspect of the present disclosure is an aspect dependent on the fourth aspect, wherein the transport section has a transport roller pair configured to nip and transport the medium, the path member is configured to hold one roller of the transport roller pair, and the nip of the transport roller pair is released by the path member being displaced to the retract position.

According to the present aspect, the path member is configured to hold one roller of the transport roller pair, and the nip of the transport roller pair is released by the path member being displaced to the retract position. With such a configuration, the path member can be retracted by opening the door section, and the nip between the transport roller pair can be released, and thus, it is possible to facilitate maintenance such as jam processing.

The medium transport device according to a sixth aspect of the present disclosure is an aspect dependent on the fifth aspect, wherein the transport roller pair is a registration roller pair configured to correct skew of the medium and the detection section is a sensor configured to detect the arrival of a leading edge of the medium transported to the registration roller pair.

According to the aspect, the transport roller pair is a registration roller pair configured to correct skew of the medium, and the detection section is a sensor configured to detect the arrival of a leading edge of the medium transported to the registration roller pair. With such a configuration, the nip of the registration roller pair can be released, and the detection section upstream of the registration roller pair can be cleaned.

The medium transport device according to a seventh aspect of the present disclosure is an aspect dependent on any one of the fourth aspect to the sixth aspect, wherein the cleaning section is configured to slide with respect to the detection surface in conjunction with displacement of the path member between the transport position and the retract position.

According to the present aspect, the cleaning section is configured to slide with respect to the detection surface in conjunction with displacement of the path member between the transport position and the retract position. With such a configuration, since the path member is retracted by opening the door section, and the cleaning section can slide in conjunction with the retraction of the path member, the sliding operation of the cleaning section can be associated with the opening and closing of the door section. Therefore, efficient operation is enabled, and usability can be improved.

The medium transport device according to an eighth aspect of the present disclosure is an aspect dependent on the seventh aspect, wherein the cleaning section has a cleaning member configured to clean the detection surface, a holding section configured to hold the cleaning member, and a slide section configured to slide the holding section by pivoting with respect to the path member and the slide section is configured to, when the path member is displaced to the retract position in a state where the slide section is in contact with a contact section of the housing, pivot with respect to the path member to slide the cleaning member with respect to the detection surface.

According to the present aspect, the slide section is configured to, when the path member is displaced to the retract position in a state where the slide section is in contact with the contact section of the housing, pivot with respect to the path member to slide the cleaning member with respect to the detection surface. With such a configuration, the slide section is pivoted by using the displacement of the path member, and the detection section is cleaned by the pivoting of the slide section, and thus, it is possible to interlock the displacement of the path member and the sliding of the cleaning member with a simple configuration.

The medium transport device according to a ninth aspect of the present disclosure is an aspect dependent on the eighth aspect, wherein the cleaning section is biased by a biasing section and the biasing section is configured to bias the cleaning section in an opposite direction to a movement direction of the cleaning section when the path member is displaced from the transport position to the retract position.

According to the present aspect, the biasing section is configured to bias the cleaning section in the opposite direction to the movement direction of the cleaning section when the path member is displaced from the transport position to the retract position. With such a configuration, the cleaning section can be returned to a desired position when the door section is in the closed state, and the cleaning section can be moved by changing the door section from the closed state to the opened state so that the detection surface can be effectively cleaned.

The medium transport device according to a tenth aspect of the present disclosure is an aspect dependent on any one of the second aspect to ninth aspect, wherein the cleaning section overlaps the transport surface as viewed in a direction orthogonal to the transport surface.

According to the present aspect, the cleaning section overlaps the transport surface as viewed in a direction orthogonal to the transport surface. With such a configuration, the cleaning section fits within the width of the transport path, and thus, it is possible to suppress an increase in the size of the medium transport device.

The medium transport device according to an eleventh aspect of the present disclosure is an aspect dependent on any one of the first aspect to tenth aspect, wherein the cleaning section is configured to slide along a width direction orthogonal to a transport direction of the medium.

According to the present aspect, the cleaning section is configured to slide along the width direction orthogonal to the transport direction of the medium. By configuring in this way and sliding the cleaning section in the width direction, it is possible to suppress an increase in the size of the medium transport device.

A recording device according to a twelfth aspect of the present disclosure includes the medium transport device according to any one of the first to eleventh aspects and a recording section configured to perform recording on the medium transported by the medium transport device.

According to the present aspect, the recording device further includes the recording section configured to perform recording on the medium transported by the medium transport device. Therefore, it is possible to perform recording on the medium which is transported by a small medium transport device.

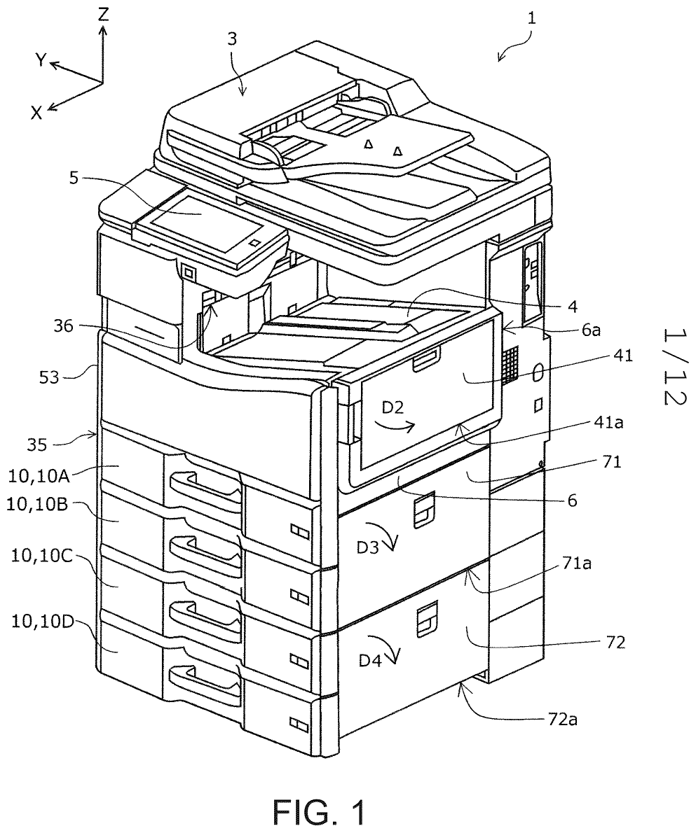

Hereinafter, a recording device 1 which is an example of a medium transport device of the present disclosure will be described with reference to FIG. 1 to FIG. 12. In an X-Y-Z coordinate system shown in each drawing, an X-axis direction indicates a front surface direction, a rear surface direction, and a medium width direction of the device, a Y-axis direction indicates a side surface direction of the device, and a Z-axis direction indicates a height direction and a gravity direction of the device. The direction in which a medium P is transported is referred to as “downstream”, and the opposite direction is referred to as “upstream”. In each drawing, some components may be omitted or simplified for easy understanding of the internal configuration and the like.

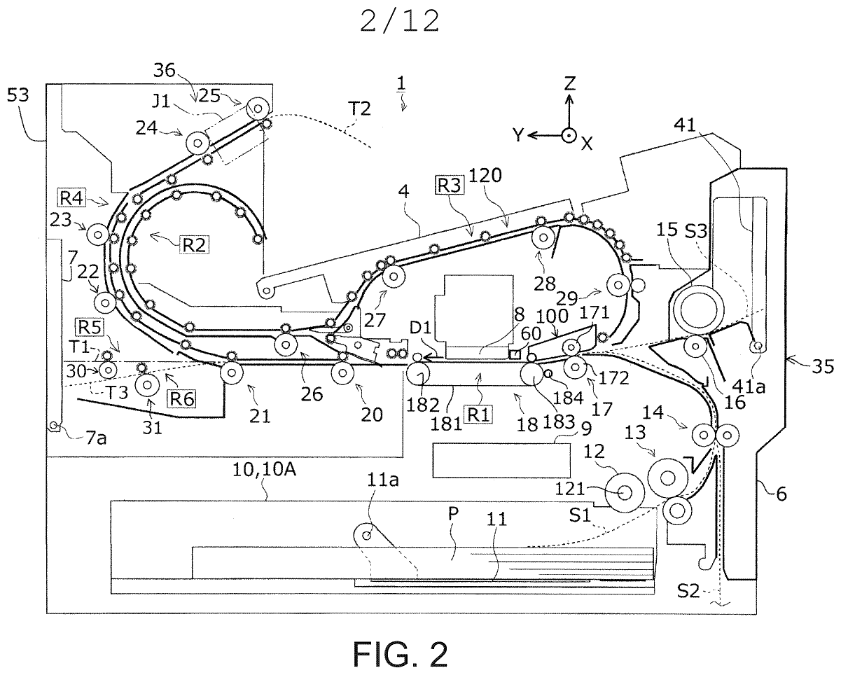

First, an overview of the recording device 1 of the present embodiment will be described with reference to FIG. 1 and FIG. 2. As shown in FIG. 1, the recording device 1 of the present embodiment is configured as a multifunction machine including a device main body 35 and a scanner unit 3. The device main body 35 includes a plurality of medium cassettes 10 that accommodate the medium P. As shown in FIG. 1, the recording device 1 of the present embodiment includes a medium cassette 10A, a medium cassette 10B, a medium cassette 10C, and a medium cassette 10D as the medium cassettes 10, and all of the medium cassettes are attachable and detachable by opening and closing along the X-axis direction.

As shown in FIG. 1, an opening and closing cover 6, which pivotable in a pivot direction D2 around a swing shaft 6a extending in the Z-axis direction, an opening and closing cover 71, which pivotable in a pivot direction D3 around a swing shaft 71a extending in the X-axis direction, and an opening and closing cover 72, which pivotable in a pivot direction D4 around a swing shaft 72a extending in the X-axis direction are provided on a side surface of a housing 53 on a −Y direction side of the recording device 1 of the present embodiment.

A user can access a medium transport path of the medium cassette 10A by pivoting the opening and closing cover 6 from the front to the back along a horizontal direction around the swing shaft 6a to open it. The user can access the medium transport path of the medium cassette 10A and the medium cassette 10B by the opening the opening and closing cover 71 by tilting it downward around the swing shaft 71a. The user can access the medium transport path of the medium cassette 10C and the medium cassette 10D by the opening the opening and closing cover 72 by tilting it downward around the swing shaft 72a. The user can remove the medium P in which a jam has occurred in these medium transport paths by accessing these medium transport paths. As shown in FIG. 2, the opening and closing cover 6 is provided with a manual feed tray 41. The manual feed tray 41 swings about a swing shaft 41a and can be opened and closed with respect to the opening and closing cover 6.

In the Z-axis direction corresponding to the height direction in the device main body 35, a discharge mechanism section 36, which discharges the medium P on which recording is executed in the line head as a recording head 8, and a discharge tray 4 on which the medium P discharged from the discharge mechanism section 36 is placed are provided between the scanner unit 3 and the medium cassettes 10. An operation section 5 is provided on the front side of the device main body 35. The operation section 5 is provided with a display unit such as a liquid crystal panel. The user can input instructions for a recording operation and an image reading operation to the recording device 1 by operating the operation section 5.

As shown in FIG. 2, the recording device 1 has three medium feed paths, that is, a feed path from the medium cassette 10A corresponding to a cassette feeding trajectory S1, a feed path from the medium cassette 10B, and the medium cassette 10C, and the medium cassette 10D corresponding to a lower cassette feeding trajectory S2, and a feed path from the manual feed tray 41 on which the medium P is placed corresponding to a manual feed path S3. The recording device 1 has three medium discharge methods, that is, a face-up discharge corresponding to a face-up discharge trajectory T1, in which a first surface on which recording has been performed most recently is discharged upward, a face-down discharge corresponding to a face-down discharge trajectory T2, in which the first surface is discharged downward, and discharge to a post-processing device corresponding to a finisher discharge trajectory T3, in which post-process is performed on the medium P connected downstream of the recording device 1.

The recording device 1 includes a face-up paper discharge tray 7 that receives the medium P discharged in a face-up discharge manner. The face-up paper discharge tray 7 can take a stored state shown in FIG. 2 and an opened state (not shown) by pivoting around a pivot shaft 7a. The recording device 1 includes six medium transport paths: a recording transport path R1, a switchback path R2, an inversion path R3, a face-down discharge path R4, a face-up discharge path R5, and a finisher discharge path R6.

The most downstream side of the face-down discharge path R4 is configured by the discharge mechanism section 36. In region J1 of FIG. 2, spurs, which are a plurality of driven rollers, are provided.

A control section 9 that performs various controls acquires recording data that is data for performing recording, which is generated by a printer driver that operates in an external computer (not shown) or a printer driver included in the control section 9. Based on the recording data, the recording head 8 of an inkjet system, various medium transport rollers driven by a motor (not shown), flaps which are path switching members, and the like are controlled. The control section 9 performs necessary control based on detection states of various sensors such as a sensor that detects passage of the medium P. In FIG. 2, the control section 9 is conceptually shown and is actually constituted by a circuit board provided at a predetermined position in the device main body 35.

Here, a medium feed path to a registration roller pair 17 will be described. The medium cassette 10A that is attachably and detachably provided to the device main body 35 is provided with a hopper 11, and the medium P that are accommodated in the medium cassette 10A are brought into contact with and separated from a feed roller 12 that is rotationally driven by a motor (not shown) by the hopper 11 swinging around a shaft 11a.

The medium P sent out from the medium cassette 10A by the feed roller 12 are separated by passing through a nip position of a separation roller pair 13, and reach the registration roller pair 17 by receiving a sending force from a transport roller pair 14 in a state where double feeding is prevented. Similarly, the medium cassette 10B, the medium cassette 10C, and the medium cassette 10D are also provided with the feed roller 12 and the separation roller pair 13, and the medium P sent out from each of the medium cassettes 10 of the medium cassette 10B, the medium cassette 10C, and the medium cassette 10D receives the sending force from the transport roller pair 14 shown in FIG. 2 and reaches the registration roller pair 17. A feed roller 15 and a separation roller 16 are provided in the manual feed path S3, which is a medium feed path from the manual feed tray 41, and the medium P set on the manual feed tray 41 reach the registration roller pair 17 by the rotation of these rollers.

The registration roller pair 17, transport roller pairs 20 to 24, transport roller pairs 26 to 31, and a discharge roller pair 25 as a discharge section that discharges the medium P are provided in the medium transport path. Each roller pair includes a drive roller driven by a motor (not shown) and a driven roller that can nip the medium P between the drive roller and the driven roller and is driven to rotate in contact with the medium P. The recording transport path R1 as a first transport path passes under the recording head 8 as a recording section that performs recording on the medium P and extends upstream and downstream thereof. In the recording transport path R1, the medium P receives a sending force from the registration roller pair 17 and a belt unit 18. The belt unit 18 includes an electrostatic adsorption belt 181 that transports the medium P, a drive roller 182 and a driven roller 183 on which the electrostatic adsorption belt 181 is wound, and a charging roller 184 that charges the electrostatic adsorption belt 181.

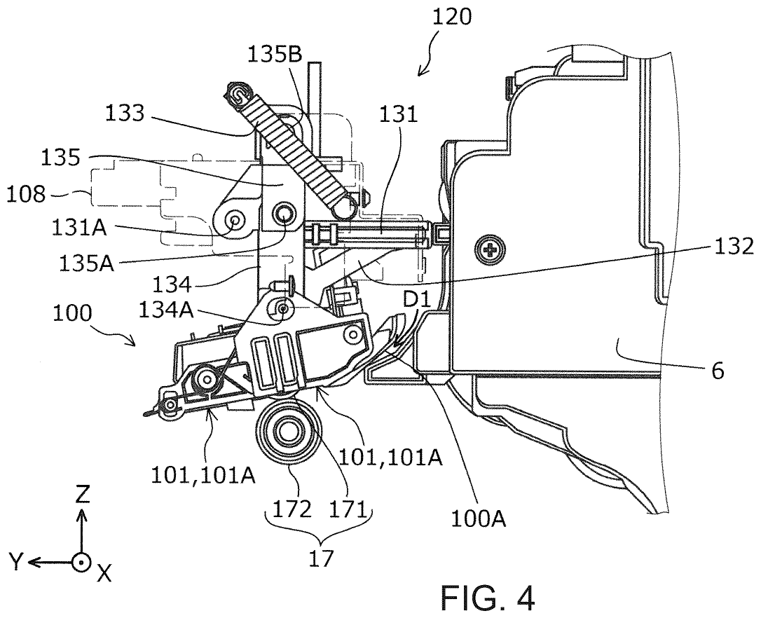

One of the rollers constituting the registration roller pair 17 is formed on a support section 100. The support section 100 is displaced by a displacement mechanism (not shown) in accordance with the opening and closing of the opening and closing cover 6. Note that the detailed configuration of the support section 100 will be described later, but the support section 100 is provided with a detection section 101 that detects the medium P, which is a main part of the recording device 1 of the present embodiment, and a cleaning section 110 that cleans a detection surface 101A of the detection section 101. In the present embodiment, as shown in FIG. 4 to FIG. 7, the detection sections 101 are provided upstream and downstream of the registration roller pair 17 in a transport direction D1 of the medium P. The detection section 101 provided upstream of the registration roller pair 17 in the transport direction D1 of the medium P is configured to detect that a leading edge of the medium P has reached the registration roller pair. Based on a detection result of the detection section 101 provided downstream of the registration roller pair 17 in the transport direction D1 of the medium P, ink is ejected from the recording head 8 (to be described later).

The recording head 8 of the present embodiment is a so-called line head in which nozzles ejecting ink are provided so as to cover the entire region in the medium width direction, and is configured as a recording head which can perform recording on the entire medium width without being moved in the medium width direction. However, in a case of a recording section that performs recording by ejecting liquid such as ink onto the medium P, the recording section is not limited to the line head. Further, a recording section that performs recording using toner may be provided instead of the recording section that ejects liquid ink. The recording device 1 of the present embodiment includes a static eliminating brush 60 that removes electric charges on the surfaces of the medium P to be transported, on the upstream of the recording head 8 in the transport direction D1 of the medium P.

The switchback path R2 as a second transport path is a medium transport path connected to the recording transport path R1, and is a path for sending into the medium P passing under the recording head 8 in a left direction in FIG. 2, and then switching back and transporting the medium P in a right direction in FIG. 2, which is the opposite direction to the sending in direction, and is positioned on the inner side of the curve with respect to the face-down discharge path R4 (to be described later). In the switchback path R2, the medium P receive a sending force from the transport roller pair 26.

The inversion path R3 as a third transport path is a medium transport path connected to the switchback path R2, and inverts the medium P transported in the opposite direction, which is to the right direction in FIG. 2, by detouring around the upper side of the recording head 8, and in the present embodiment, merges with it at a position upstream of the recording head 8 on the recording transport path R1, which is the upstream position of the registration roller pair 17. In the inversion path R3, the medium P receives sending forces from the transport roller pairs 27, 28, and 29.

The face-down discharge path R4 as a fourth transport path is a medium transport path connected to the recording transport path R1, and is a path for discharging the medium P that has passed under the recording head 8 by bending and inverting the medium P with the surface facing the recording head 8 facing inward. In the face-down discharge path R4, the medium P receive sending forces from the transport roller pairs 20, 21, 22, 23, and 24 and the discharge roller pair 25. The most downstream of the face-down discharge path R4 is configured by the discharge mechanism section 36 as described above. A flap as a path switching member that switches the medium transport path is provided at a connecting section of each medium transport path. The path along which the medium P travels is set by the flap.

As described above, the face-up discharge path R5 as a fifth transport path is a path for discharging the medium P that have passed under the recording head 8 to the face-up paper discharge tray 7 such that the surface facing the recording head 8 faces upward. A transport roller pair 30 is provided in the face-up discharge path R5. As described above, the finisher discharge path R6 as a sixth transport path is a discharge path to the post-processing device in a case where the post-processing device or the like, which performs post-processing on the medium P, is connected downstream of the recording device 1. A transport roller pair 31 is provided in the finisher discharge path R6.

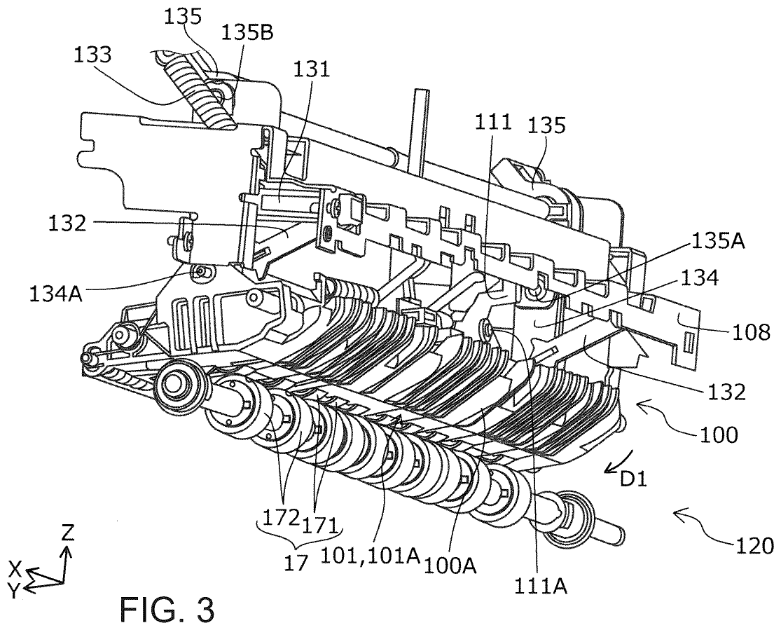

Here, as shown in FIG. 2, the recording device 1 of the present embodiment is provided with a transport section 120 for transporting the medium P, which is composed of the electrostatic adsorption belt 181, the registration roller pair 17, the transport roller pairs 20 to 24, the transport roller pairs 26 to 31, and the discharge roller pair 25 as a discharge section for discharging the medium P. Further, as described above, the recording device 1 of the present embodiment includes the support section 100, the housing 53, which accommodates s the transport section such as the electrostatic adsorption belt 181 and the support section 100, and the opening and closing cover 6 as a door section which opens and closes the housing 53. Note that the support section 100 includes a roller 171 that constitute the registration roller pair 17 and can be expressed to constitute the transport section 120. Next, the detailed configuration of the support section 100 will be described with reference to FIG. 3 to FIG. 12.

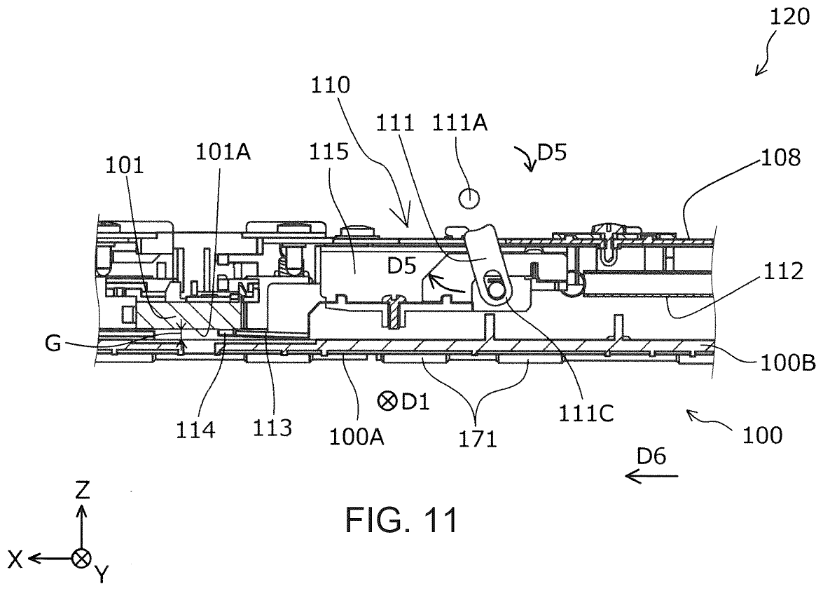

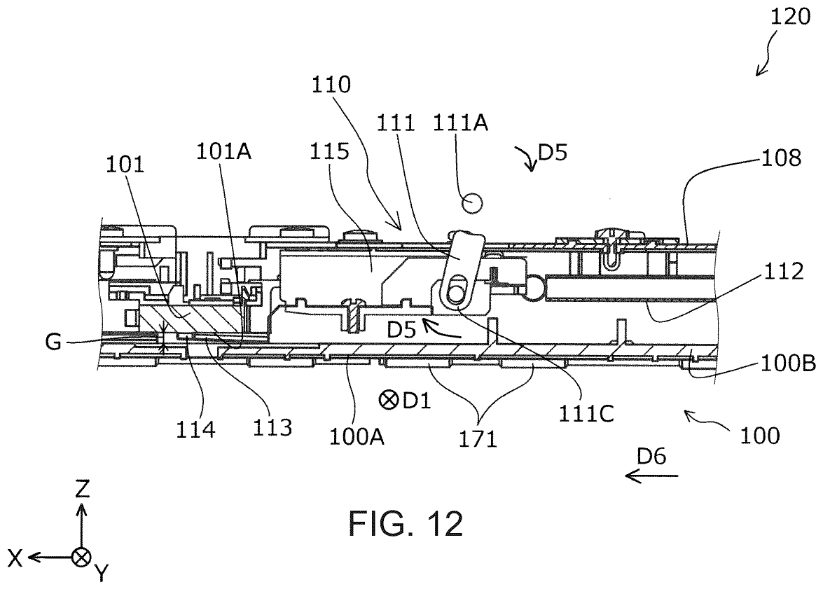

As shown in FIG. 11 and FIG. 12, the support section 100 is provided with the detection section 101, which is a sensor capable of detecting the arrival of the leading edge of the transported medium P and has the detection surface 101A, and the cleaning section 110, which cleans the detection surface 101A. The cleaning section 110 can move from the position shown in FIG. 11 to the position shown in FIG. 12 and can clean the detection surface 101A. Specifically, the cleaning section 110 can move from the position, for example, shown in FIG. 11 to the position shown in FIG. 12 in conjunction with the opening and closing of the opening and closing cover 6, and a cleaning member 114 provided in the cleaning section 110 slides with respect to the detection surface 101A in accordance with such movement, whereby the detection surface 101A can be cleaned. As in the recording device 1 of the present embodiment, by adopting a configuration in which the cleaning section 110 slides with respect to the detection surface 101A of the detection section 101, it is possible to reduce the space inside the housing 53 for cleaning and to suppress an increase in the size of the medium transport device. Since the recording device 1 of the present embodiment is configured to perform cleaning in conjunction with opening and closing of the opening and closing cover 6, which is an example of a door section, and thus, a dedicated power source or the like is not necessary, and thus, it is possible to suppress costs. Note that, as described above, in the present embodiment, the detection sections 101 are provided at two positions upstream and downstream of the registration roller pair 17 in the transport direction DI of the medium P, but the cleaning section 110 can clean both detection sections 101 at the same time. That is, the detection section 101 of the present embodiment can clean a plurality of detection sections 101 at the same time.

The recording device 1 of the present embodiment is a medium transport device and is a printer including the recording head 8 as a recording section that performs recording on the medium P transported by the transport section such as the electrostatic adsorption belt 181. Therefore, it is possible to express the device as a device which can perform recording on the medium P transported by a small medium transport device.

Here, a mechanism in which the cleaning section 110 moves in conjunction with the opening and closing of the opening and closing cover 6 will be described. As shown in FIG. 3 to FIG. 6, a frame section 108 that holds the support section 100 in a swingable manner is provided with a pushing lever 131 connected to the support section 100 via a connecting section 132. Here, the support section 100 and the connecting section 132 are both connected to a first pivot section 134 at a pivot shaft 134A, the first pivot section 134 and a second pivot section 135 are connected at a pivot shaft 135A, and the second pivot section 135 and the pushing lever 131 are connected at a pivot shaft 131A. The pushing lever 131 is pushed in a +Y direction by the opening and closing cover 6 in a state where the opening and closing cover 6 is closed as shown in FIG. 4.

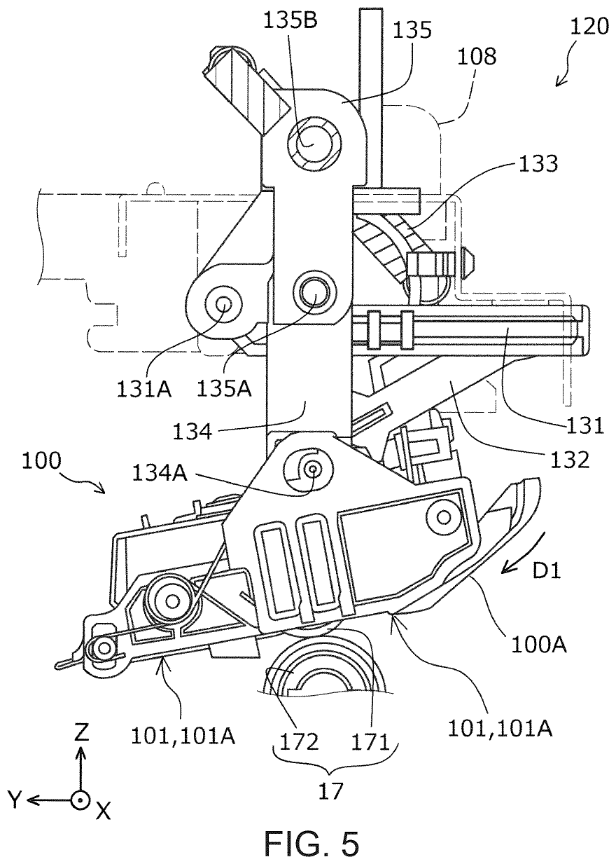

The recording device 1 of the present embodiment is configured as described above, and thus, when the opening and closing cover 6 is opened and the pushing lever 131 moves in the −Y direction, the state of FIG. 5 displaces to the state of FIG. In other words, the pivot shaft 134A, the pivot shaft 135A, and the pivot shaft 131A are displaced in a state of being moved in the −Y direction. The second pivot section 135 is held to be pivotable with respect to the frame section 108 on a pivot shaft 135B. Therefore, the pivot shaft 135B does not move in the Z-axis direction corresponding to the vertical direction. As a result, when the pivot shaft 134A, the pivot shaft 135A, and the pivot shaft 131A move in the −Y direction, these pivot shafts move in the +Z direction, which is the upward direction, and the support section 100 also moves upward.

The pushing lever 131 is pushed in the +Y direction by the opening and closing cover 6 in a state shown in FIG. 4, that is, in a state where the opening and closing cover 6 is closed. FIG. 3 to FIG. 5 show a state where the pushing lever 131 is pushed in the +Y direction by the opening and closing cover 6. In this state, the support section 100 is pushed downward in a −Z direction by the connecting section 132 and the first pivot section 134. When the support section 100 is pushed in the −Z direction, a nip is formed between the roller 171, which constitutes the registration roller pair 17 and is provided on the support section 100, and a roller 172, which constitutes the registration roller pair 17 and is fixed in position inside the housing 53. The position of the support section 100 in FIG. 3 to FIG. 5 corresponds to a transport position at which the medium P is transported.

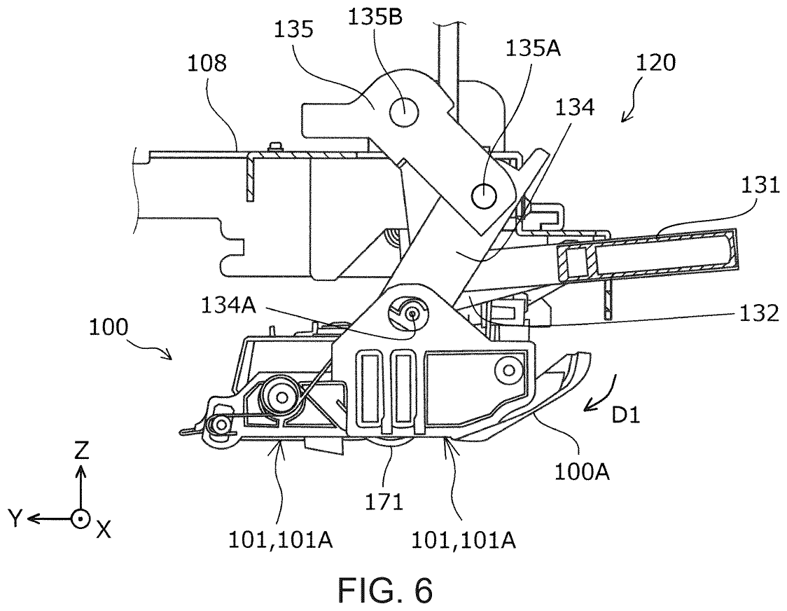

On the other hand, the second pivot section 135 is provided with a spring 133 that biases the second pivot section 135 so that a spring pressure is applied to the pushing lever 131 in the −Y direction, and the pushing lever 131 moves in the −Y direction by the spring pressure received from the spring 133 stretched over the second pivot section 135 in a state where the opening and closing cover 6 is opened. FIG. 6 shows a state in which the pushing lever 131 is moved in the −Y direction by the spring pressure received from the spring 133. In this state, the support section 100 is pulled upward in the +Z direction by the connecting section 132 and the first pivot section 134. When the support section 100 is pulled in the +Z direction, the roller 171 is separated from the roller 172. When the opening and closing cover 6 is opened and the roller 171 is separated from the roller 172, the medium P nipped between the roller 171 and the roller 172, for example, the medium P jammed in the recording transport path R1 or the inversion path R3 can be easily taken out. The position of the support section 100 in FIG. 6 corresponds to a retract position retracted from the transport position.

In the recording device 1 of the present embodiment, the transport section 120 has the support section 100 as a path member, which configures the medium transport path, and as shown in FIG. 3 to FIG. 12, the support section 100 includes a transport surface 100A, which faces the medium P transported when transporting the medium P. As shown in FIG. 11 and FIG. 12, the detection section 101 is provided in the support section 100 as a path member. In the case of a configuration in which the detection section 101 is provided in the path member, depending on the device configuration, the path member may be moved together when cleaning the detection section 101, and there is a concern that the movement space of the path member or the configuration for moving the path member may be increased in size. However, the recording device 1 of the present embodiment can be configured such that the cleaning section 110 slides with respect to the detection section 101, and thus it is possible to suppress an increase in the size of the recording device 1.

Note that the above description does not deny that the detection section 101 and the path member move integrally. For example, in the configuration of the present embodiment, the support section 100 and the detection section 101 move integrally when the nip between the roller 171 and the roller 172 is released, but this does not deny the movement for purposes other than when the detection section 101 is cleaned.

The support section 100 of the present embodiment can be displaced to the transport position at which the medium P is transported as shown in FIG. 3 to FIG. 5 and the retract position at which the support section 100 is retracted from the transport position as shown in FIG. 6. As described above, it takes in the transport position when the opening and closing cover 6 closed and takes in the retract position when the opening and closing cover 6 opened. In the recording device 1 of the present embodiment, since the support section 100 is retracted by opening the opening and closing cover 6 by adopting such a configuration, it is possible to facilitate maintenance such as jam processing.

As described above, the transport section 120 of the present embodiment has the registration roller pair 17 as a transport roller pair that nips and transports the medium P. The support section 100 of the present embodiment holds one roller 171 of the registration roller pair 17, and as shown in FIG. 6, the nip of the registration roller pair 17 is released by the support section 100 being displaced to the retract position. The recording device 1 of the present embodiment is configured as described above, since the support section 100 is retracted by opening the opening and closing cover 6 and the nip of the registration roller pair 17 can be released, maintenance such as jam processing can be easily performed.

Here, the registration roller pair 17 of the present embodiment is a registration roller pair that corrects skew of the medium P by the leading edge of the medium P being transported being contacted against the registration roller pair 17, and the detection section 101 of the present embodiment is a sensor that can detect arrival of the leading end of the medium P being transported to the registration roller pair 17. The recording device 1 of the present embodiment is configured as described above, and thus it is possible to release the nip of the registration roller pair 17 and possible to clean the detection section 101 upstream of the registration roller pair 17 in the transport direction D1. In particular, paper dust is generally likely to be generated when the medium P contacts against the registration roller pair 17, but the usability is improved by easily cleaning the registration roller pair 17 as described above.

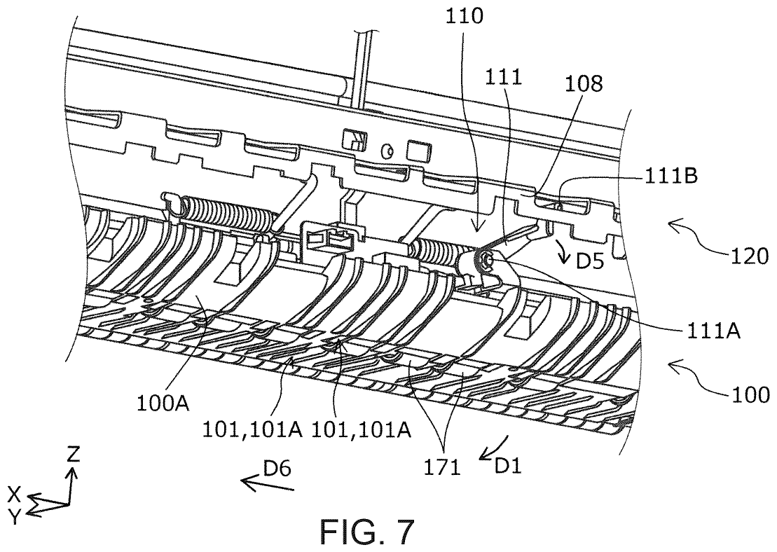

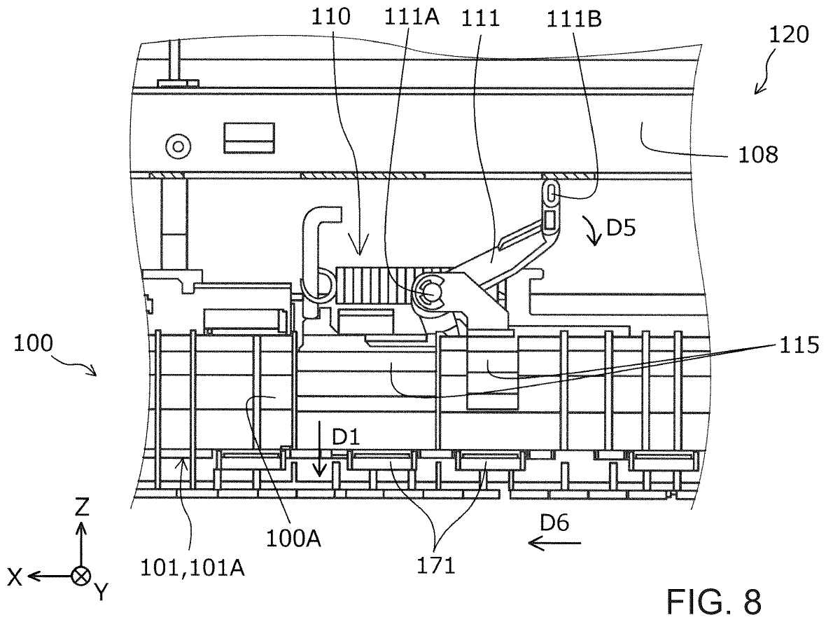

Here, a sliding mechanism in which the cleaning section 110 slides on the detection surface 101A of the detection section 101 will be described. As shown in FIG. 7 to FIG. 12, the cleaning section 110 of the present embodiment includes a lever 111 that pivots around a pivot shaft 111A. At the transport position corresponding to the state of FIG. 7, a tip end 111B of the lever 111 is separated from the frame section 108, but when the opening and closing cover 6 is opened and the support section 100 starts to move to the retract position, the tip end 111B of the lever 111 contacts the frame section 108. Then, when the support section 100 further moves to the retract position in a state where the tip end 111B of the lever 111 contacts the frame section 108, the lever 111 pivots in the pivot direction D5. Note that, although the state in FIG. 8 is a little difficult to see, it is in the same state as in FIG. 7, with the opening and closing cover 6 closed, the support section 100 is positioned at the lower side, and the tip end 111B of the lever 111 is separated from the frame section 108, similarly to the state of FIG. 7.

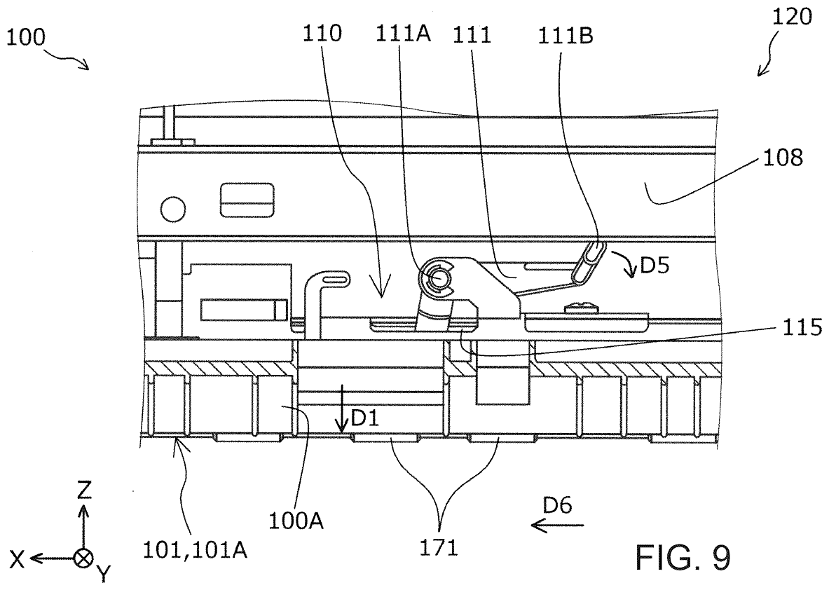

On the other hand, FIG. 9 shows a state in which the opening and closing cover 6 is opened, the support section 100 is positioned at the upper side, and the tip end 111B of the lever 111 contacts the frame section 108. As is clear from a comparison between FIG. 8 and FIG. 9, by becoming the state of FIG. 8 to the state of FIG. 9, the lever 111 pivots in the pivot direction D5.

The lever 111 is connected to a slider 115 at a lower end section 111C as shown in FIG. 11 and FIG. 12. Therefore, when the lever 111 pivots in a pivot direction D5 around the pivot shaft 111A, the slider 115 moves in a sliding direction D6. A flat plate section 113 is connected to the slider 115, and the cleaning member 114 made of sponge, cloth, or the like is attached to a tip end of the flat plate section 113 at the sliding direction D6. As described above, the detection section 101 of the present embodiment can clean the plurality of detection sections 101 at the same time. In the present embodiment, a flat plate section (not shown) is provided in the slider 115 separately from the flat plate section 113, and a cleaning member (not shown) is provided in the flat plate section separately from the cleaning member 114. The cleaning member 114 cleans the detection section 101 provided upstream of the registration roller pair 17 in the transport direction D1 of the medium P. The cleaning member (not shown) cleans the detection section 101 provided downstream of the registration roller pair 17 in the transport direction D1 of the medium P. With such a configuration, the plurality of detection sections 101 can be cleaned with a simple configuration. However, a plurality of cleaning members may be provided on the same flat plate section 113, or the plurality of detection sections 101 may be cleaned by the same cleaning member 114.

Note that the transport surface 100A of the support section 100 is formed on one surface of a plate-shaped member 100B, but as shown in FIG. 11 and FIG. 12, the flat plate section 113 and the cleaning member 114 are provided in a gap G between the plate-shaped member 100B and the detection surface 101A of the detection section 101 as viewed from the Y-axis direction. The cleaning member 114 moves in the sliding direction D6 in the gap G to clean the detection surface 101A.

As described above, in the recording device 1 of the present embodiment, the transport section 120 has the support section 100, which configures the transport path of the medium P, the support section 100 has the transport surface 100A, and the medium P are transported to face the transport surface 100A. The detection section 101 is provided on the opposite side of the transport surface 100A with respect to the plate-shaped member 100B of the support section 100, and the cleaning section 110 slides with respect to the detection surface 101A by moving in the sliding direction D6 corresponding to the direction along the transport surface 100A in the gap G between the plate-shaped member 100B and the detection section 101.

In other words, the detection section 101 is integrally configured with the support section 100, and the detection surface 101A is positioned at a position recessed from the transport surface 100A. In general, such a configuration makes it difficult to clean the detection surface 101A. Therefore, in the recording device 1 of the present embodiment, the cleaning section 110 is configured to slide with respect to the detection surface 101A by moving in the direction along the transport surface 100A in the gap G between the support section 100 and the detection section 101. With such a configuration, it is possible to effectively clean the detection surface 101A and to dispose the detection section 101 on the inner side of the transport surface 100A of the support section 100, and it is possible to suppress a decrease in detection accuracy due to the detection section 101 rubbing against the medium P.

On the other hand, the configuration in which the detection section 101 moves to perform cleaning as in the related art may lead to an increase in the size of the device. However, the recording device 1 of the present embodiment is configured such that the cleaning section 110 slides with respect to the detection section 101 between the support section 100 and the detection section 101, and thus it is possible to suppress an increase in the size of the device.

In the recording device 1 of the present embodiment, the support section 100 is displaced between the transport position and the retract position in accordance with the opening and closing of the opening and closing cover 6, and the cleaning section 110 slides with respect to the detection surface 101A in conjunction with the displacement of the support section 100 between the transport position and the retract position. With such a configuration, since it causes the support section 100 to retract by opening the opening and closing cover 6 and the cleaning section 110 can be slid in conjunction with the retraction of the support section 100, the sliding operation of the cleaning section 110 can be associated with the opening and closing action of the opening and closing cover 6. Therefore, efficient operation is enabled, and usability can be improved.

As described above, the cleaning section 110 of the present embodiment has the cleaning member 114 that cleans the detection surface 101A, the slider 115 as a holding section that holds the cleaning member 114, and the lever 111 as a slide section that slides the slider 115 by pivoting with respect to the support section 100. When the support section 100 is displaced to the retract position in a state where the lever 111 contacts the frame section 108 as a contact section of the housing 53, the lever 111 pivots with respect to the support section 100 and slides the cleaning member 114 with respect to the detection surface 101A. With such a configuration, the lever 111 is pivoted by using the displacement of the support section 100 and the detection section 101 can be cleaned by the pivoting of the lever 111, and the displacement of the support section 100 and the sliding of the cleaning member 114 can be interlocked with each other with a simple configuration.

As shown in FIG. 11 and FIG. 12, the cleaning section 110 of the present embodiment has a spring 112 as a biasing section, and the slider 115 is biased by the spring 112. In detail, the spring 112 biases the slider 115 of the cleaning section 110 in a opposite direction to the sliding direction D6, which is a movement direction of the cleaning section 110 when the support section 100 is displaced from the transport position to the retract position.

With such a configuration, the cleaning section 110 can be returned to the desired position as shown in FIG. 11 when the opening and closing cover 6 is closed state, and the cleaning section 110 can be moved by changing from the closed state of the opening and closing cover 6 shown in FIG. 11 to the opened state of the opening and closing cover 6 shown in FIG. 12, so that the detection surface 101A can be effectively cleaned. Note that in the present embodiment, the slider 115 is biased, but the present disclosure is not limited to such a configuration, and for example, a configuration in which the lever 111 is biased or a configuration in which the flat plate section 113 is biased may be employed.

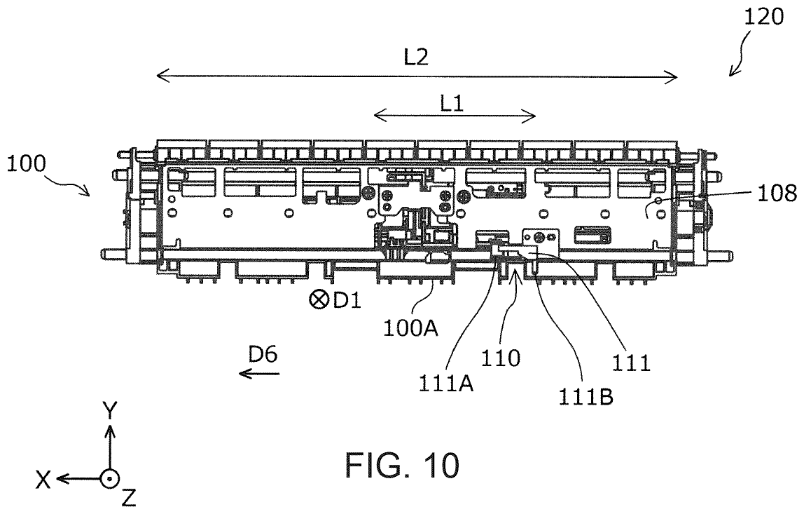

Here, the cleaning section 110 of the present embodiment overlaps the transport surface 100A as viewed in a direction orthogonal to the transport surface 100A. In other words, in FIG. 10, a length L1 of the cleaning section 110 in the medium width direction is within the range of a length L2 of the transport surface 100A in the medium width direction. With such a configuration, the cleaning section 110 is accommodated in the width of the medium transport path, and thus it is possible to suppress an increase in the size of the device. Note that, although not limited to such a configuration, it is particularly desirable that the cleaning section 110 including the lever 111, the flat plate section 113, and the like is fitted within the width of the medium transport path.

As described above, the cleaning section 110 of the present embodiment slides along the medium width direction orthogonal to the transport direction D1 of the medium P. With such a configuration, the cleaning section 110 slides in the medium width direction, and thus it is possible to suppress an increase in the size of the device. In detail, in a case where the medium transport path is curved as viewed from a direction intersecting the transport direction D1 as in the transport surface 100A of the present embodiment when sliding in a direction along the transport direction D1, it is necessary to curve the sliding space of the cleaning section 110 depending on the shape of the medium transport path. In this case, a large sliding space for the cleaning section 110 may be required. On the other hand, in a case where the cleaning section 110 slides along the medium width direction as in the present embodiment, there is no need to curve the sliding space of the cleaning section 110, and thus it is possible to reduce the sliding space of the cleaning section 110.

The present disclosure is not limited to the present embodiments and the modifications described above, and various modifications can be made within the scope of the disclosure described in the claims, and it is needless to say that these are also included in the scope of the present disclosure. The sensor in the present disclosure may be a transmissive optical sensor, a reflective optical sensor, or an ultrasonic sensor.

What is claimed is:

1. A medium transport device comprising:
a transport section configured to transport a medium;
a detection section that has a detection surface and that is configured to detect the medium transported by the transport section via a detection surface;
a cleaning section configured to clean the detection surface;
a housing configured to house the transport section, the detection section, and the cleaning section; and
a door section configured to open and close the housing, wherein
the cleaning section is configured to slide with respect to the detection surface in conjunction with opening and closing of the door section.

2. The medium transport device according to claim 1, wherein
the transport section has a path member that configures a transport path of the medium,
the path member has a transport surface,
the medium is transported facing the transport surface,
the detection section is provided on the opposite side than the transport surface with respect to the path member, and
the cleaning section is configured to slide with respect to the detection surface by moving in a direction along the transport surface in a gap between the path member and the detection section.

3. The medium transport device according to claim 1, wherein
the transport section has a path member that configures a transport path of the medium,
the path member has a transport surface,
the medium is transported facing the transport surface, and the detection section is provided in the path member.

4. The medium transport device according to claim 3, wherein
the path member
is configured to displace between a transport position where the medium is transported and a retract position where the medium is retracted from the transport position and
takes the transport position when the door section is closed and takes the retract position when the door section is open.

5. The medium transport device according to claim 4, wherein
the transport section has a transport roller pair configured to nip and transport the medium,
the path member is configured to hold one roller of the transport roller pair, and
the nip of the transport roller pair is released by the path member being displaced to the retract position.

6. The medium transport device according to claim 5, wherein
the transport roller pair is a registration roller pair configured to correct skew of the medium and
the detection section is a sensor configured to detect the arrival of a leading edge of the medium transported to the registration roller pair.

7. The medium transport device according to claim 4, wherein
the cleaning section is configured to slide with respect to the detection surface in conjunction with displacement of the path member between the transport position and the retract position.

8. The medium transport device according to claim 7, wherein
the cleaning section has
a cleaning member configured to clean the detection surface,
a holding section configured to hold the cleaning member, and
a slide section configured to slide the holding section by pivoting with respect to the path member and
the slide section is configured to, when the path member is displaced to the retract position in a state where the slide section is in contact with a contact section of the housing, pivot with respect to the path member to slide the cleaning member with respect to the detection surface.

9. The medium transport device according to claim 8, wherein
the cleaning section is biased by a biasing section and
the biasing section is configured to bias the cleaning section in an opposite direction to a movement direction of the cleaning section when the path member is displaced from the transport position to the retract position.

10. The medium transport device according to claim 2, wherein
the cleaning section overlaps the transport surface as viewed in a direction orthogonal to the transport surface.

11. The medium transport device according to claim 1, wherein
the cleaning section is configured to slide along a width direction orthogonal to a transport direction of the medium.

12. A recording device comprising:
the medium transport device according to claim 1 and
a recording section configured to perform recording on the medium transported by the medium transport device.
